(19) United States
(12) Patent Application Publication
(10) Pub. No.: US 2005/0205353 A1
(43) Pub. Date: Sep. 22, 2005

(54) Automobile muffler

(76) Inventor: Hui-Fang Chen, Taipei (TW)

Correspondence Address: BRUCE H. TROXELL, SUITE 1404, 5205 LEESBURG PIKE, FALLS CHURCH, VA, 22041, US

(21) Appl. No.: 10/852,174

(22) Filed: May 25, 2004

(30) Foreign Application Priority Data
Mar. 16, 2004 (TW) 093203948

(51) Int. Cl. F02B 19/00; F01N 1/08; F01N 1/12

(52) U.S. Cl. 181/270; 181/279

(57) ABSTRACT

An automobile muffler comprising an inner board with a gas-in tube is installed on one side, a outer board with at least one gas-out tube is on the other side, an external hood covers the inner and outer boards vertically to form a chamber, a plurality arrow shape bars are installed horizontally along two spiral lines inside the chamber; two adjacent arrow shape bars are installed with special angle without vacant space; the tips of the arrow shape bars face the gas-in tube, the side wings form an included angle with the tip. When the high pressure, high temperature exhaust gas by engine enters the chamber from the gas-in tube, the exhaust gas is divided and dispersed by the arrow shape bars and forms disturbance condition, the exhaust gas collides to lower the noise level; the arrow shape bars increase the contact time and area with gas that lowers the temperature and pressure effectively.

### BACKGROUND OF THE INVENTION

I. Field of the Invention

This invention relates generally to a muffler and, more specifically, to an automobile muffler that is applied on automobile engine to reduce engine noise.

II. Description of the Prior Art

Heretofore, it is known that engines of automobiles produce exhaust gas with high pressure and high temperature; most of the known mufflers are filled with noise reduction cotton in straight-line structure, or have partitions to disturb exhaust gas to reduce noise with cotton and partitions. However the known mufflers simply reduce noise and cannot increase exhaust gas flow rate, some automobiles still cannot exhaust smoothly, such condition not only effects power but also causes more gasoline consumption and shortens engines' life.

Mufflers with partitions can lower noise level, however when the exhaust gas is disturbed, resonance is generated on the inner wall of the mufflers. Most of the straight line designs with cotton have a metal net internally to absorb high temperature of exhaust gas, the heat absorbed by metal net and noise absorbed by cotton to achieve lower temperature and normal pressure exhaust gas; however such design only has noise reduction cotton on the exhaust gas path, the noise reduction only has limited effect.

### SUMMARY OF THE INVENTION

It is therefore a primary object of the invention to provide an automobile muffler that has the exhaust gas generated by engine divided and dispersed by the spiral shape arranged arrow shape bars to have the gas collides to lower the noise level; the installation of the arrow shape bars increases the contact time and area with gas that lowers the temperature and pressure effectively.

In order to achieve the objective set forth, an automobile muffler in accordance with the present invention comprises an inner board with a gas-in tube is installed on one side, a outer board with at least one gas-out tube is on the other side, an external hood covers the inner and outer boards vertically to form a chamber, a plurality arrow shape bars are installed horizontally along two spiral lines inside the chamber; two adjacent arrow shape bars are installed with special angle without vacant space; the tips of the arrow shape bars face the gas-in tube, the side wings form an included angle with the tip. When the high pressure, high temperature exhaust gas by engine enters the chamber from the gas-in tube, the exhaust gas is divided and dispersed by the arrow shape bars and forms disturbance condition, the exhaust gas collides to lower the noise level; the arrow shape bars increase the contact time and area with gas that lowers the temperature and pressure effectively.

It is still an object for the invention to provide an automobile muffler in which the length and thickness of the arrow shape bars are adjustable to meet different requirement of different engines.

### BRIEF DESCRIPTION OF THE DRAWINGS

The accomplishment of the above-mentioned object of the present invention will become apparent from the following description and its accompanying drawings which disclose illustrative an embodiment of the present invention, and are as follows:

FIG. 1 is a perspective view of the present invention;

FIG. 2a is a side cross-sectional view of the present invention;

FIG. 2b is a top cross-sectional view of the present invention; and

FIG. 3 is an application view of the present invention.

### DESCRIPTION OF THE PREFERRED EMBODIMENT

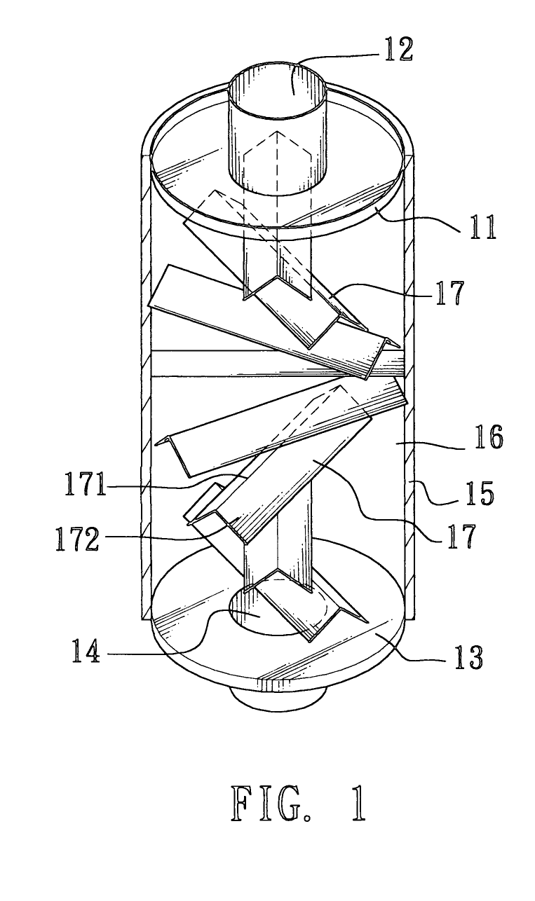

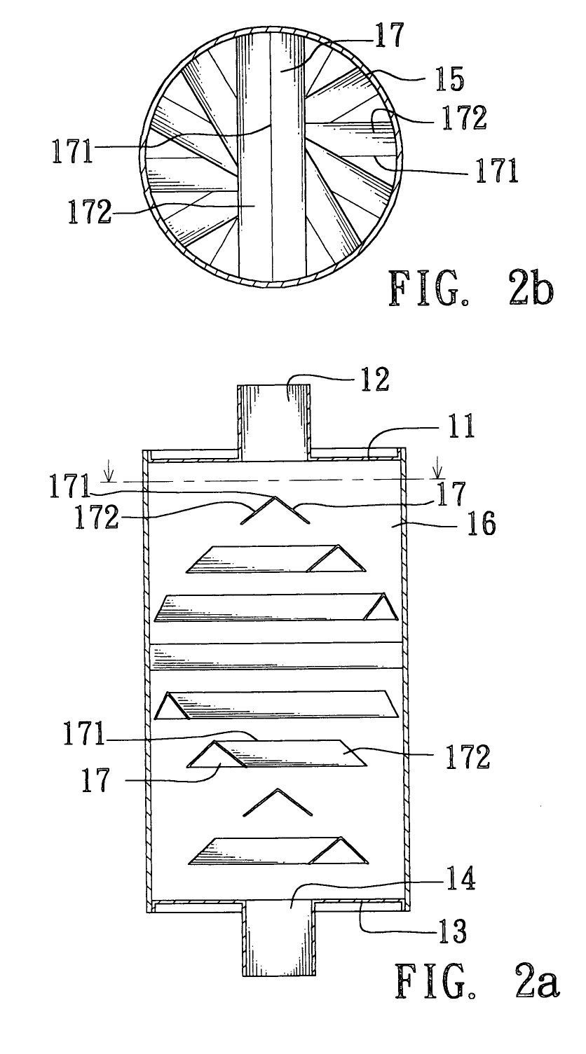

Referring to FIG. 1 through FIG. 2b, the muffler 1 of the present invention is in tube shape, an inner board 11 with a gas-in tube 12 is installed on one side of the muffler 1, a outer board 13 with at least one gas-out tube 14 is on the other side of the muffler 1, an external hood 15 covers the inner and outer boards 11, 13 vertically to form a chamber 16.

The major characteristic of the present invention is to have a plurality arrow shape bars 17 installed horizontally along two spiral lines inside the chamber 16; since the arrow shape bars 17 are installed along two spiral lines, therefore the arrangement looks like ladder, two adjacent arrow shape bars 17 are installed with special angle without vacant space, as shown in FIG. 2b. The tips 171 of the arrow shape bars 17 face the gas-in tube, one of the side wings 172 forms an included angle with the tip is around 25° to 45°, the best angle is 38°; the length of the arrow shape bars is from 25 mm to 50 mm, the best length is 38 mm; the thickness of the side wings 172 is from 1.00 mm to 2.00 mm, the best thickness is 1.25 mm; however in real application, these are not limited, the thickness of the side wings 172 vibrate along with the gas flow and form self-interference condition to lower the noise.

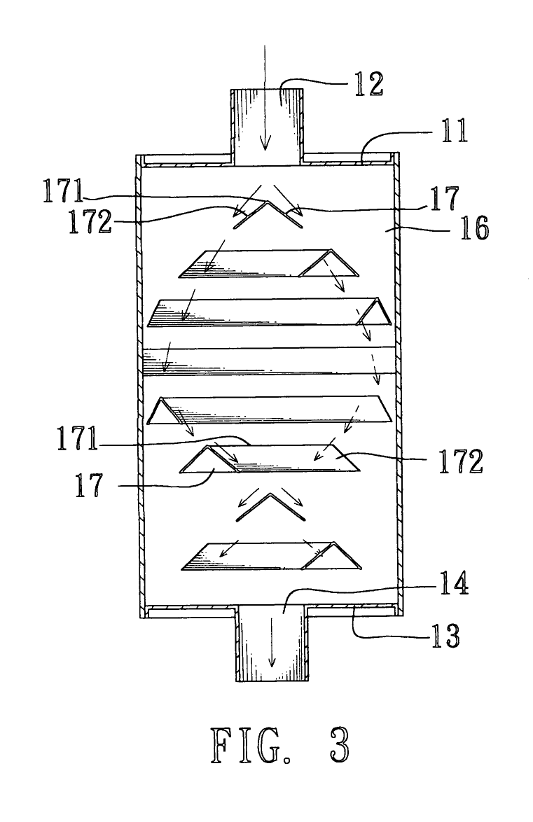

In real application, as shown in FIG. 3, when the high pressure, high temperature exhaust gas by engine enters the chamber 16 from the gas-in tube 12, the exhaust gas is divided and dispersed by the arrow shape bars 17 and forms disturbance condition, the exhaust gas is divided and dispersed by the spiral shape arranged arrow shape bars 17 to have the gas collides to lower the noise level; the installation of the arrow shape bars 17 increases the contact time and area with gas that lowers the temperature and pressure effectively, the disturbance condition also lowers the noise level effectively.

The application of the present invention not only reduces the resonance condition as the partition design but also improves the poor noise absorbability of the noise reduction cotton, and makes the engine power output smoothly, achieves gasoline saving and longer engine life effect. The length and thickness of the arrow shape bars of present invention are adjustable to meet different requirement of different engines.

While a preferred embodiment of the invention has been shown and described in detail, it will be readily understood and appreciated that numerous omissions, changes and additions may be made without departing from the spirit and scope of the invention.

1. An automobile muffler comprising:
an inner board with a gas-in tube is installed on one side, a outer board with at least one gas-out tube is on the other side, an external hood covers said inner and said outer boards vertically to form a chamber, a plurality arrow shape bars are installed horizontally along two spiral lines inside said chamber, two adjacent said arrow shape bars are installed with special angle without vacant space, the tips of said arrow shape bars face said gas-in tube, the side wings form an included angle with the said tip, when the high pressure, high temperature exhaust gas by engine enters said chamber from said gas-in tube, the exhaust gas is divided and dispersed by said arrow shape bars and forms disturbance condition, the exhaust gas collides to lower the noise level, said arrow shape bars increase the contact time and area with gas that lowers the temperature and pressure effectively.

2. The automobile muffler recited in claim 1, wherein the length and thickness of said arrow shape bars are adjustable to meet different requirement of different engines.

3. The automobile muffler recited in claim 1, wherein the included angle formed by said tip and one of said side wings ranges from 25° to 45°.

4. The automobile muffler recited in claim 3, wherein the included angle formed by said tip and one of said side wings is 38°.

5. The automobile muffler recited in claim 1, wherein the length of said arrow shape bars is from 25 mm to 50 mm.

6. The automobile muffler recited in claim 5, wherein the length of said arrow shape bars is 38 mm.

7. The automobile muffler recited in claim 1, wherein the thickness of said side wings is from 1.00 mm to 2.00 mm.
